(19) United States
(12) Patent Application Publication
(10) Pub. No.: US 2008/0028353 A1
(43) Pub. Date: Jan. 31, 2008

(54) METHOD FOR TREATING PARASITIC RESISTANCE, CAPACITANCE, AND INDUCTANCE IN THE DESIGN FLOW OF INTEGRATED CIRCUIT EXTRACTION, SIMULATIONS, AND ANALYSES

(76) Inventors: Ning Lu, Essex Junction, VT (US); Scott K. Springer, Burlington, VT (US)

Correspondence Address: LAW OFFICE OF DELIO & PETERSON, LLC., 121 WHITNEY AVENUE, NEW HAVEN, CT, 06510, US

(21) Appl. No.: 11/458,240

(22) Filed: Jul. 18, 2006

(51) Int. Cl. G06F 17/50

(52) U.S. Cl. 716/13

(57) ABSTRACT

An extraction, simulation, and analysis combined method is employed to account for the parasitic couplings from interconnect wires. Variations of parasitic resistance, capacitance, and inductance are used in circuit analysis calculators, including considering the variations of the parasitics on worst case circuit performance, skewing, and statistical Monte Carlo analysis. Each parasitic element is modeled as a call-up function with associated process distributions. Circuit analysis, such as a SPICE analysis is performed on the selected models.

### BACKGROUND OF THE INVENTION

1. Field of the Invention

This invention relates to a method for calculating parasitic resistance, capacitance, and inductance in a semiconductor device design. More particularly, the invention relates to Very Large Scale Integrated Circuit (VLSI) chips utilizing submicron technology, and specifically to a method of calculating and treating parasitic resistance, capacitance, and inductance in the design flow of integrated circuit extraction, simulations, and analyses.

2. Description of Related Art

Large interconnect parasitic resistances, capacitances, and inductances play an important role in assessing the delay of signals and in predicting the effects of system-generated noise. The parasitic information, once extracted, may be used in chip timing calculations and noise induction. In VLSI designs, on-chip signal delay is increasingly dominated by the RC delay associated with signal lines. The dielectric structures available in advanced IC designs can have a substantial effect on the signal line capacitance, resistance, and inductance values. For instance, signal line parasitic capacitance has a detrimental role in signal propagation, causing unanticipated and unwanted delays. With semiconductor process techniques achieving smaller IC dimensions, parasitic coupling plays a larger role in performance characteristics. In deep submicron technologies, coupling capacitance significantly dominates the total parasitic capacitance. Interconnect parasitics have at least two effects: 1) delay due to different switching patterns; and 2) induced glitches or noise that could cause functional failure by switching logic states. Consequently, design simulations need to accommodate and accurately predict the detrimental effects that parasitic resistances, capacitances, and inductances have on the overall signal line propagation and system operation. Unlike the signal delay in an active device itself, which is usually well characterized and within an analytical tool's device library, a line delay depends on the structures in the vicinity of the line, and thus cannot be accurately modeled or calculated until all the circuit elements associated with the signal path are placed and routed. Thus, signal propagation delay due to parasitic-induced coupling is difficult to predict and accommodate through design enhancements without an accurate estimate of its overall effect in the circuit layout.

Several methods have been employed to predict coupled capacitances and resistances for signal lines. These methods include exact closed-form solutions, approximate formulae, such as those for calculating linear capacitance or capacitance per-unit-length, and detailed numerical solutions. The exact closed-form method is limited in geometry, and not practical for application with highly dense integrated circuit topologies. Approximate formulae are generally used in extraction programs, but lack the accuracy necessary to predict capacitance and inductance coupling for advanced integrated circuit chips. These methods for predicting parasitic impedances are typically based on a simplistic model that often takes into account only the dimensions of the individual lines.

Extraction tools allow the user to layout a physical description of the circuit, and view the shape of the design. Generally, wire-cap models are employed to analyze the circuit functions and parasitic couplings. Device level simulation models, such as SPICE, simulate the circuit operation using discrete models including models for parasitic couplings. SPICE is a general-purpose circuit simulation program for nonlinear dc, nonlinear transient, and linear ac analyses. Circuits may contain resistors, capacitors, inductors, mutual inductors, independent voltage and current sources, dependent sources, lossless and lossy transmission lines, switches, uniform distributed RC lines, and common semiconductor devices, such as diodes, BJTs, JFETs, MESFETs, and MOSFETs. SPICE is available from the University of California at Berkeley, via the Department of Electrical Engineering and Computer Sciences. Several EDA vendors offer commercial SPICE simulators, such as Hspice from Synopsys, and Spectre and UltraSim from Cadence. In order to perform a SPICE simulation of a circuit, all of the nodes between every component in the circuit need to be numbered. Once the nodes are identified, the type of components at each node and the component magnitudes are entered into the SPICE program. Unfortunately, the number of nodes that need to be entered in a VLSI chip is quite large, and could be overwhelming.

The output of an extraction tool yields fixed values for parasitic parameters based on the length and width of a signal line, and its space to neighboring lines. An extraction tool generally generates either a nominal value or a set of three values, including a nominal, plus a lower bound and an upper bound, for characterizing parasitics. The extraction tool reads data from files containing circuit design information and outputs a net-list identifying the design. The net-list may then be used as an input to a device level model simulator, such as the aforementioned SPICE simulator.

Models used to extract and estimate parasitic resistance, capacitance, and inductance values have been employed in the prior art with success, but with considerable design limitations. In U.S. Pat. No. 6,643,831 issued to Chang, et al., on Nov. 4, 2003, entitled “METHOD AND SYSTEM FOR EXTRACTION OF PARASITIC INTERCONNECT IMPEDANCE INCLUDING INDUCTANCE,” a parasitic extraction system is taught including an interconnect primitive library that has a parameterized inductance function for at least one conducting layer of the integrated circuit. A parasitic extractor analyzes structures within a selected distance of a selected conductor within the integrated circuit chip and determines the parasitic inductance values for the selected conductor using the parameterized inductance function of the interconnect primitive library. Using this parasitic extraction system, parasitic impedances may be extracted for an integrated circuit layout.

In U.S. Pat. No. 6,530,066 issued to Ito, et al., on Mar. 4, 2003, entitled “METHOD OF COMPUTING WIRING CAPACITANCE, METHOD OF COMPUTING SIGNAL PROPAGATION DELAY DUE TO CROSS TALK AND COMPUTER-READABLE RECORDING MEDIUM STORING SUCH COMPUTED DATA,” a method of computing wiring capacitance is taught for obtaining parasitic capacitance depending upon the wiring at high speed, and of computing signal propagation delay due to cross-talk. Total capacitance per unit length is determined about each of a plurality of models that alter adjacent wiring and crossing ratios. A library of this data is then formed.

In the prior art methodologies described above, and in many others generally used in the industry, device models employed do not account for the parasitic couplings from interconnect wires. Moreover, to the extent that such parasitics are addressed, the outputs of extraction tools for wire models yield results that generally form fixed upper, lower, and nominal bounds, which then may be inputs for statistical analysis, such as in a Monte Carlo simulation. Common extraction tools, such as Synopsys' StarRcxt, Mentor Graphics'CalibrXrc, Cadence Assura's RCX, Diva, and Sequence's Columbus RF, read design layout files and do device recognition. In this process, device models are selected. For example, FETs and passive device models may contain process distributions and their affects on model behavior. Parasitic wire resistor elements and capacitor elements are added. Nominal circuit performance is generally the normal mode of operation for the simulation. In these instances, each resistor element and capacitor element is a constant, limiting the analytical results to discrete values.

The prior art lacks the capability to include variations of parasitic resistance, capacitance, and inductance for analysis. The prior art is further deficient in considering the variations of parasitics on worst case circuit performance. Moreover, under the current analytical regimes, due to the discrete nature of the data, worst case or best case circuit performance may not be relied upon to be sufficiently accurate.

### SUMMARY OF THE INVENTION

Bearing in mind the problems and deficiencies of the prior art, it is therefore an object of the present invention to provide a method of addressing parasitic resistance, inductance, and capacitance in an extraction tool that is not limited to the best case, worst case, and nominal values only.

It is another object of the present invention to provide a method of treating parasitic resistance, capacitance, and inductance in the design of IC extraction, simulations, and analyses, which accounts for wire width variations, wire height variations, via height variations, and the like.

A further object of the invention is to provide a method of treating parasitic resistance, capacitance, and inductance in the design of IC extraction, simulations, and analyses, which treats parasitics as device models in order to get correct process variations in Monte Carlo simulations, skewing, and tracking with other device model behavior.

Still other objects and advantages of the invention will in part be obvious and will in part be apparent from the specification.

The above and other objects, which will be apparent to those skilled in the art, are achieved in the present invention, which is directed in a first aspect to a method for modeling parasitic couplings in integrated circuit simulations comprising: reading layout files of the integrated circuit circuitry; performing device recognition; assigning FET and passive device models to components of the integrated circuit circuitry recognized during the device recognition; identifying routes for the parasitic couplings of interconnect wires in the integrated circuit circuitry; assigning parasitic coupling model functions for each of the routes for the parasitic couplings; analytically treating the parasitic coupling model functions as device models during the integrated circuit simulation. The method further includes obtaining process variations for the parasitic coupling model functions treated as the passive device models. The process variations may be statistically modeled by a Monte Carlo analysis, by skewing, or by worst case circuit performance analysis. The worst case analysis includes setting wire parameters to one corner, which corresponds to a worst case (maximum) total capacitance, and setting wire parameters to another corner, which corresponds to the worst case (maximum) line-to-line coupling capacitance. The parasitic coupling model functions include analytical functions for continuous prediction features.

In a second aspect, the present invention is directed to a method for simulating and analyzing parasitic interconnect couplings in an integrated circuit model, comprising: inputting circuit layout information within an extraction tool; generating semiconductor technology files for the integrated circuit model; generating model process files; inputting the semiconductor technology files and the model process files into a circuit analysis simulator; inputting variational parameters associated with the model process files into the circuit analysis simulator; and performing circuit analysis on the integrated circuit model. The circuit analysis simulator includes a SPICE simulator. The variational parameters include statistically generated Monte Carlo variations or worst case circuit performance variations, or skewing.

In a third aspect, the present invention is directed to a program storage device readable by a machine, tangibly embodying a program of instructions executable by the machine to perform method steps for simulating and analyzing parasitic interconnect couplings, the method steps comprising: inputting circuit layout information within an extraction tool; generating semiconductor technology files for the integrated circuit model; generating model process files; inputting the semiconductor technology files and the model process files into a circuit analysis simulator; inputting variational parameters associated with the model process files into the circuit analysis simulator; and performing circuit analysis on the integrated circuit model.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a two-dimensional model of the present invention simulating wire parasitic capacitance and resistance.

FIG. 2 depicts the two-dimensional model of FIG. 1 with parasitic capacitance models shown.

FIG. 3 depicts a limiting case of a semi-isolated wire for analyzing parasitic wire resistance and capacitance.

FIG. 4 depicts a fully isolated wire model having center interconnect line capacitively coupled to two perpendicular interconnect lines.

FIG. 5 depicts a wire parasitic model for interconnect lines over a perpendicular signal line with no nearby upper level wires.

FIG. 6 depicts the coupling scenario where there are no nearby upper level wires or same level wires.

FIG. 7 depicts a five-level configuration (three-dimensional model) where parasitic couplings from an interconnect line to other interconnect lines at one level above and two levels above as well as to other interconnect lines at one level below and two levels below under study may be represented.

FIG. 8 depicts the parasitic capacitance coupling from an FET gate to nearby contact CA, where contact CA is electrically connected to M1 above it and to diffusion layer RX below it.

FIG. 9 depicts a flow chart of the extraction, simulation, and analysis flow of the present invention.

### DESCRIPTION OF THE PREFERRED EMBODIMENT(S)

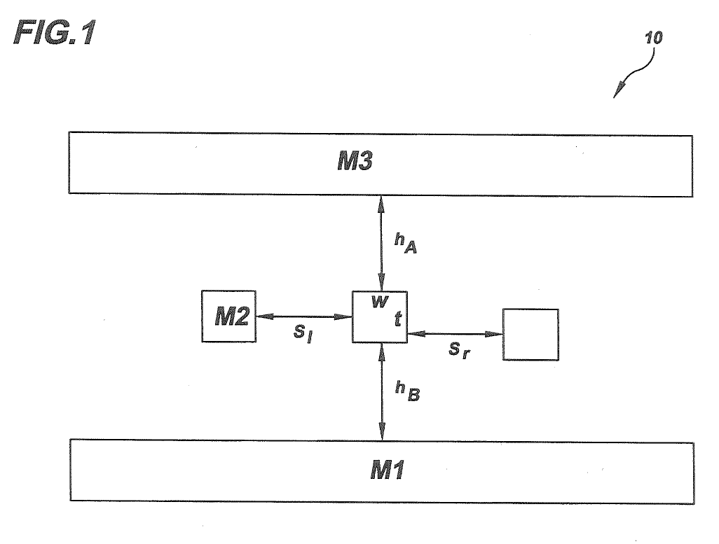

In describing the preferred embodiment of the present invention, reference will be made herein to FIGS. 1-9 of the drawings in which like numerals refer to like features of the invention.

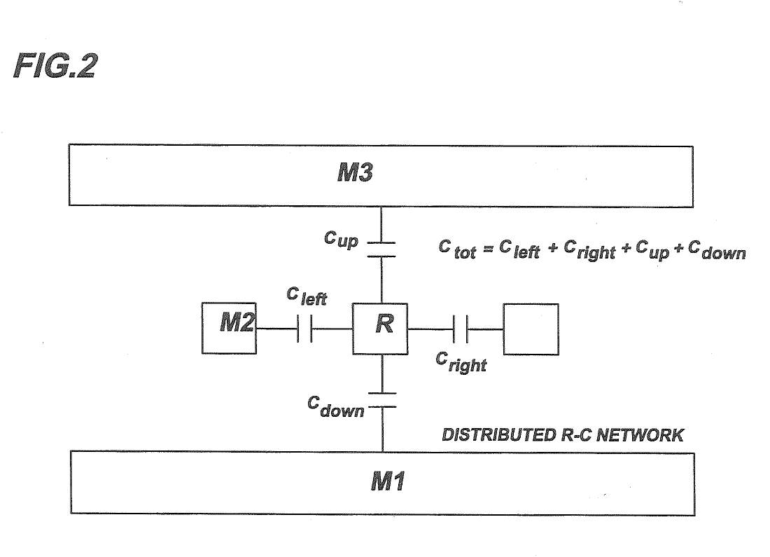

FIG. 1 depicts a two-dimensional model 10 of the present invention simulating wire parasitic capacitance and resistance. Two current carrying, parallel metal signal or interconnect lines M1 and M3 are shown a distance h_{A} and h_{B}, respectively, from three interconnect lines M2, which are perpendicular to the direction and layout of M1 and M3 (shown in the figure as going through the page). The interconnect lines have a known width w and height or thickness t, and are placed a distance s₁ from the (first) neighboring wire on the left, and a distance sᵣ from the (first) neighboring wire on the right. The resistance of M2 is at a minimum when the width w and thickness t are maximized. Under this condition, the line-to-line coupling capacitance, C_{M2-M2} (including both C_{left}, and C_{right}), the capacitance from the M2 wire at the center to M1 lines below, C_{M2-M1} (also referred to as C_{down}), and the capacitance from the M2 wire at the center to the M3 lines above, C_{M2-M3} (also referred to as Cᵤₚ), are larger. The largest value of total capacitance Cₜₒₜₐₗ will occur when the width w and thickness t are maximized and h_{A}, h_{B} are minimized. The largest line-to-line coupling capacitance C_{M2-M2} will occur when the width w, thickness t, and distances h_{A} and h_{B} are maximized. The parasitic coupling to each metal line of a distributed RC network is depicted from the center metal line under study, and capacitively represented by Cᵤₚ, C_{down}, C_{left}, and C_{right}, as depicted in FIG. 2. The total parasitic capacitance is the summation of each modeled parasitic capacitor: Cₜₒₜₐₗ=Cᵤₚ+C_{down}+C_{left}+C_{right}=C_{M2-M3}+C_{M2-M1}+2*C_{M2-M1}. Two separate process corners are required for analysis. Inter-level capacitances C_{M2-M1} and C_{M2-M3} are maximized when the width, w, and the thickness, t, are maximized, while heights h_{A}, h_{B} are minimized; but line-to-line coupling capacitance C_{M2-M2} is not at a maximum under the same conditions. Similarly, when the governing parameters w, t, h_{A}, and h_{B} are all maximized, line-to-line coupling capacitance C_{M2-M2} is at its maximum, but inter-level capacitances C_{M2-M1} and C_{M2-M3} are not.

The present invention forms parasitic resistor elements for each wire, where each resistor element is a model call, or a set of library functions, with distribution values for a given modeling program. It also adds parasitic wire capacitor elements where each capacitor element is a model call with its own distributions. By allowing the parasitic values to be represented by modeled algorithmic functions, instead of discrete values, it is possible to predict the detrimental affects that each interconnect line will have on its adjacent neighbors under various configuration scenarios, including frequency dependent conditions.

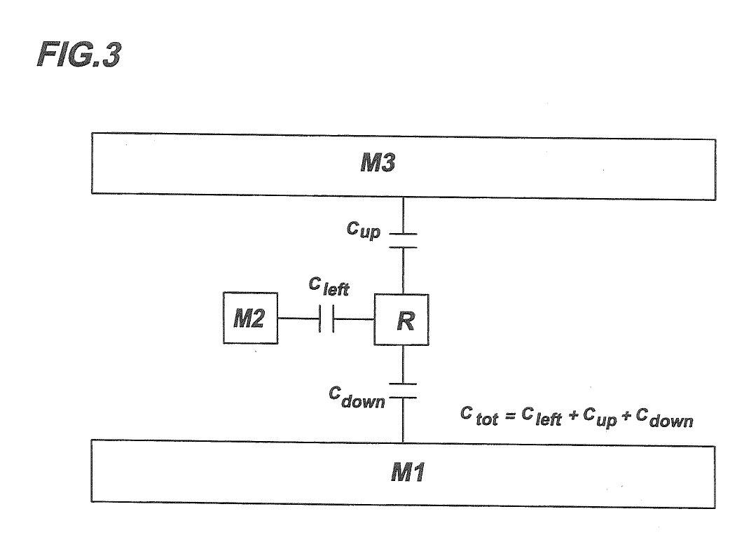

FIG. 3 depicts a limiting case of a semi-isolated wire for analyzing parasitic wire resistance and capacitance that cannot be easily attained by the prior art method. In a semi-isolated wire condition, M1 and M3 are shown parallel to one another with two M2 interconnect lines running perpendicular therewith. The interconnect line under study, the center M2 line, is given a resistance value R based on the dimensions of the line, and modeled with parasitic capacitance to the adjacent M1, M2, and M3 lines, with capacitors C_{down}, C_{left}, and Cᵤₚ, respectively. In this instance, the total capacitance from the center interconnect line, Cₜₒₜₐₗ, is the sum of the individual parasitic capacitances, such that: Cₜₒₜₐₗ=C_{left}+Cᵤₚ+C_{down}.

Generally, models require a skewing parameter for each predicted value of parasitic coupling, which usually entails maximum, minimum, and nominal values. The present invention involves modeling the wire parasitics as call-up model functions, which allows for continuous analytical skewing results. For example, the capability of adding wire capacitor elements to the analysis as a model call with distributions allows for continuous skewing of separate couplings for the inter-level M2-M1 and M2-M3 capacitors and the line-to-line M2-M2 capacitor.

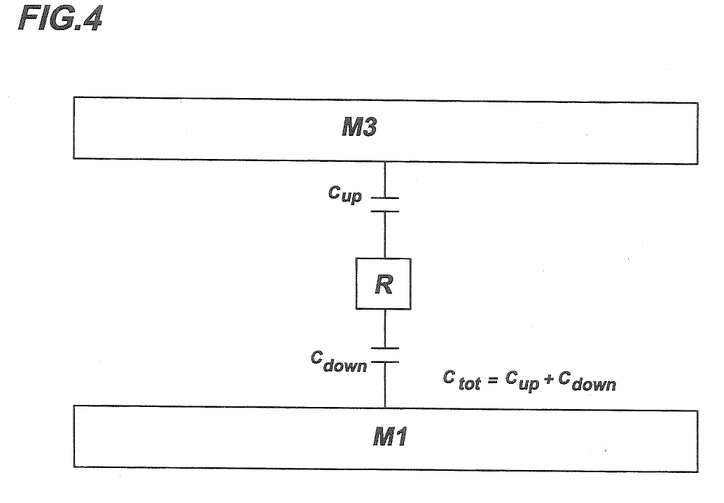

FIG. 4 depicts a fully isolated wire model having center interconnect line capacitively coupled to two perpendicular interconnect lines M1, M3. The center interconnect line is modeled with a resistor element R based on the line dimensions, and individual parasitic capacitance C_{down} and Cᵤₚ to M1 and M3, respectively. Each capacitor and resistor value is associated with a model call-up function within the analysis tool. The total parasitic capacitance affecting the signal propagation of the center interconnect line is represented by the sum of the individual parasitic capacitance values: Cₜₒₜₐₗ=Cᵤₚ+C_{down}.

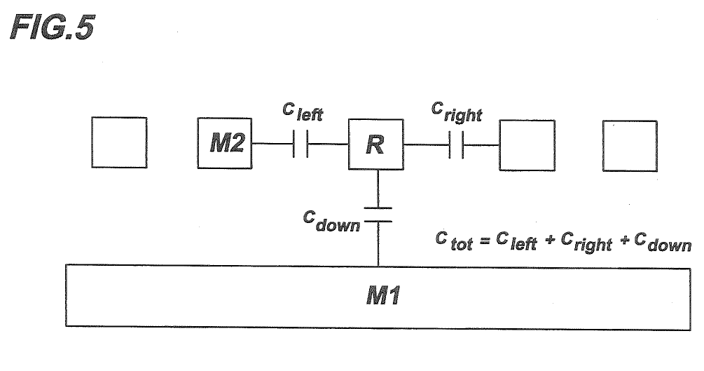

The parasitic model call-up feature of the present invention may also be employed when no nearby upper level wires are configured. FIG. 5 depicts a wire parasitic model for interconnect lines M2 over a perpendicular signal line M1 with no nearby upper level wires. The center interconnect line under study is modeled with a resistor element R, and given the model call-up parasitic capacitances functions C_{left}, C_{right}, and C_{down}, which capacitively connect the center line to adjacent signal lines. The total parasitic capacitance affecting the signal propagation and time delay of the center interconnect line is represented by the sum of the individual parasitics: Cₜₒₜₐₗ=C_{left}+C_{right}+C_{down}.

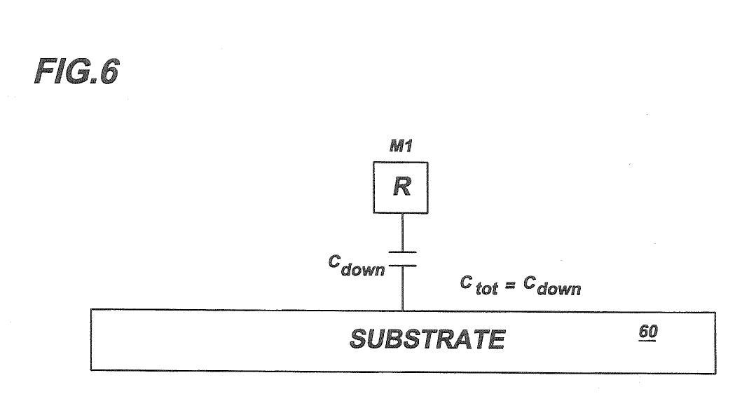

FIG. 6 depicts the simplest coupling scenario, where there are no nearby upper level wires or same level wires. Interconnect line M1 is shown with resistance R, and capacitively coupled directly to the substrate 60. In this configuration, a single model call-up is sufficient to represent the parasitic affects on the signal performance of M1. The total parasitic capacitance is shown as the single capacitor model, C_{down}, between M1 and the substrate, such that Cₜₒₜₐₗ=C_{down}.

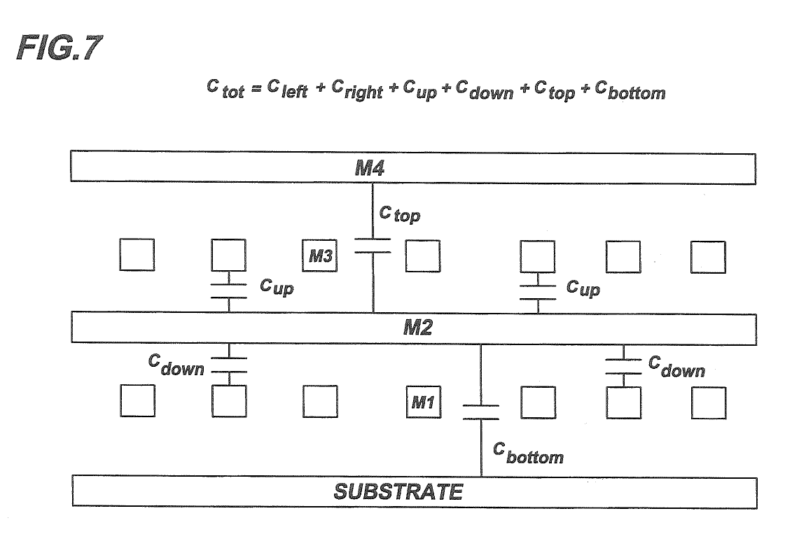

FIG. 7 depicts a five-level configuration (3D model) where parasitic couplings from interconnect line M2 connects to interconnect line M3, one level above, and M4, two levels above, and from M2 to interconnect line M1, one level below, and the substrate, two levels below. As depicted in FIG. 7, the total parasitic capacitance Cₜₒₜₐₗ is the sum of the individual parasitic capacitor model call-ups surrounding the interconnect line under study: Cₜₒₜₐₗ=C_{left}+C_{right}+Cᵤₚ+C_{down}+Cₜₒₚ+C_{bottom}. The parasitic modeling call-up feature allows the user to handle multiple sub-layer designs. Moreover, in the modeling prediction of a device, the parasitic modeling functions allow one to account for the calculation of coupling influences on signal performance.

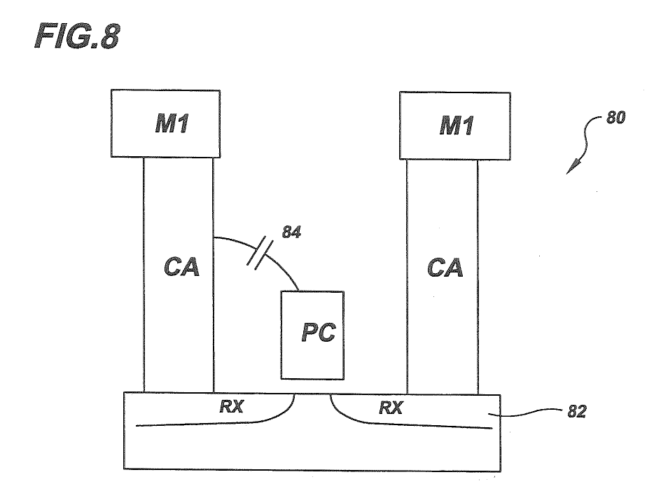

FIG. 8 depicts the parasitic capacitance coupling 84 from a FET poly (PC) gate 80 to contact CA. Contact CA is electrically connected to M1 above it and to diffusion layer RX below it. Here, the parasitic capacitance 84 from the PC gate to the CA+M1 portion of the device may be modeled under various scenarios for determining the operation of the FET, and the detrimental affects that the parasitics will have on the FET's signal.

In a general analytical tool such as SPICE, and the like, the three-level (2D wire model) and five-level (3D wire model) parasitic coupling models of the present invention may be coded as a set of functions which may be linked with the tool's simulator. This allows for the wire parasitic models to be heavily used in schematic simulations and analysis of critical nets. The present invention may also be used as a stand-alone tool for parameterizing the timing of circuits or devices.

Moreover, the present invention may be employed as part of a base algorithm for an extraction tool. In this manner, an extraction tool algorithm utilizing the present invention would generally include the following steps: a) reading the layout files; b) performing device recognition; c) calling active devices models; d) calling passive device models; e) calling parasitic coupling models; f) treating the parasitic coupling models as device model calls to obtain process variations in Monte Carlo analysis, skewing, and tracking with other device model behavior. The parasitic models will have continuous prediction features, where the variations of the parasitic couplings may be used in Monte Carlo simulations and worst case circuit performance calculations

Additionally, the present invention may be effectively used during ring-oscillator simulations where the effects of parasitic resistance and capacitance can no longer be ignored. Variations in parasitic couplings are needed for best case/worst case simulation scenarios and Monte Carlo statistical simulations.

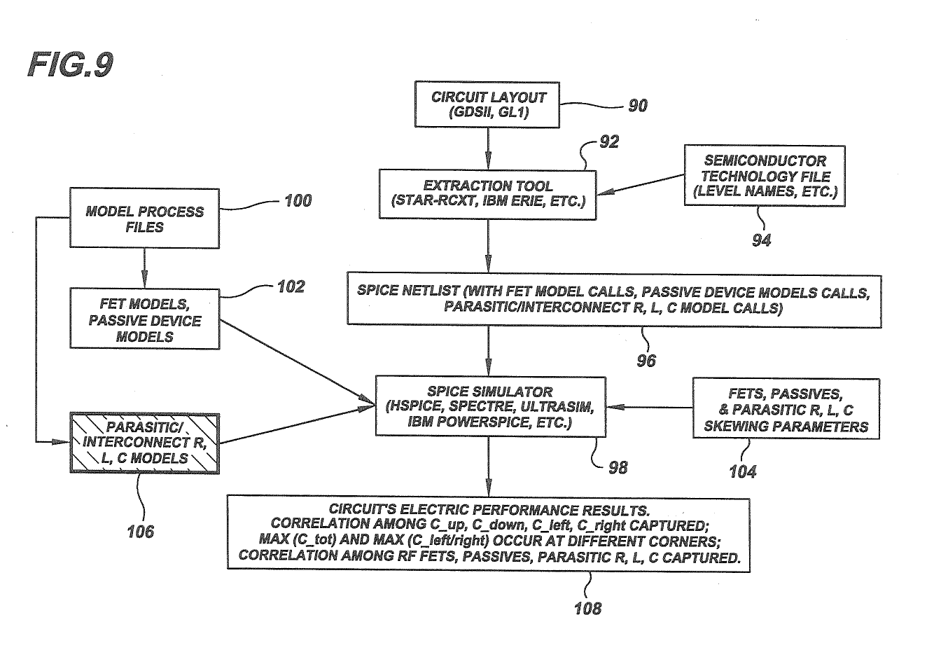

The extraction, simulation, and analysis flow of the present invention may be represented by the flow chart of FIG. 9. A circuit layout 90 is inputted to the extraction tool 92. The extraction tool may be Synopsys' StarRcxt, Mentor Graphics'CalibrXrc, Cadence Assura's RCX, Diva, Sequence's Columbus RF Star-Rcxt, CalibrXrc, IBM's Efficient Rapid Integrated Extraction (ERIE), or the like. A semiconductor technology file 94, which includes BEOL level scheme, level names, and the like, is fed into the extraction tool 92. A SPICE netlist 96 is created. The netlist will include FET model calls, passive device model calls, and parasitic resistance, capacitance, and inductance model calls. The netlist is then input into a SPICE simulator 98, such as HSPICE, Spectre, UltraSim, IBM PowerSpice, and the like. Also inputs to the SPICE simulator 98 include model process files 100 for FET models, passive device models 102, and parasitic skewing parameters 104. Unique to the present invention, the model process files 100 are used to generate the parasitic interconnect R, L, C model functions 106, which are also input to the SPICE simulator 98. The output of the SPICE simulator 98 results in an analytical assessment of the circuit's electrical/electronic performance results 108. Correlation among the parasitic couplings above, below, right, and left of an interconnect line is captured. Correlation among the RF FETs, passive devices, and parasitic couplings (R, L, and C) are also captured.

Implementing the present invention in an extraction tool would include the following steps: a) read the layout files; b) perform device recognition; c) call FET models and passive device models, wherein the models contain process distributions and their effects on model behavior; d) modeling each parasitic wire resistor element as a model call-up with associated distributions, with each distribution being able to continuously vary from its own 3σ minimum (best case or worst case) value to its nominal value and then to its 3σ maximum (worst case or best case) values; e) adding parasitic capacitive and/or inductive wire elements as model call-ups with associated distributions; f) enabling Monte Carlo analysis and/or skewing on the element models; and g) performing circuit analysis of the selected models.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method for modeling parasitic couplings in integrated circuit simulations comprising:
reading layout files of said integrated circuit circuitry;
performing device recognition;
assigning FET and passive device models to components of said integrated circuit circuitry recognized during said device recognition;
identifying routes for said parasitic couplings of interconnect wires in said integrated circuit circuitry;
assigning parasitic coupling model functions for each of said routes for said parasitic couplings;
analytically treating said parasitic coupling model functions as device models during said integrated circuit simulation.

2. The method of claim 1 including obtaining process variations for said parasitic coupling model functions treated as said passive device models.

3. The method of claim 2 including having said process variations statistically modeled by a Monte Carlo analysis.

4. The method of claim 2 including having said process variations modeled by skewing or by worst case circuit performance analysis.

5. The method of claim 4 wherein said worst case analysis includes setting wire parameters to one corner which corresponds to a worst case (maximum) total capacitance, and setting wire parameters to another corner which corresponds to the worst case (maximum) line-to-line coupling capacitance.

6. The method of claim 1 wherein said parasitic coupling model functions include analytical functions for continuous prediction features.

7. The method of claim 1 wherein each of said parasitic coupling model functions is a complete device model call-up or set library function.

8. The method of claim 7 wherein said parasitic coupling model functions include associated distributions values.

9. The method of claim 1 wherein said parasitic coupling model functions include capacitive, resistive, or inductive modeling elements.

10. A method for simulating and analyzing parasitic interconnect couplings in an integrated circuit model, comprising
inputting circuit layout information within an extraction tool;
generating semiconductor technology files for said integrated circuit model;
generating model process files;
inputting said semiconductor technology files and said model process files into a circuit analysis simulator;
inputting variational parameters associated with said model process files into said circuit analysis simulator; and
performing circuit analysis on said integrated circuit model.

11. The method of claim 10 wherein said circuit analysis simulator includes a SPICE simulator.

12. The method of claim 10 wherein said variational parameters includes statistically generated Monte Carlo variations.

13. The method of claim 10 wherein said variational parameters includes worst case circuit performance variations or skewing.

14. The method of claim 10 wherein said parasitic interconnect couplings include device model call-ups for interconnect resistance, inductance, and capacitance.

15. The method of claim 10 wherein said parasitic interconnect couplings include analytical functions for continuous prediction features.

16. The method of claim 10 wherein said model process files include FET models, passive device models, and parasitic interconnect models, and said model process files affect results of said FET models, said passive device models, and said parasitic interconnect models, in Monte Carlo or corner simulations.

17. A program storage device readable by a machine, tangibly embodying a program of instructions executable by the machine to perform method steps for simulating and analyzing parasitic interconnect couplings, said method steps comprising:
inputting circuit layout information within an extraction tool;
generating semiconductor technology files for said integrated circuit model;
generating model process files;
inputting said semiconductor technology files and said model process files into a circuit analysis simulator;
inputting variational parameters associated with said model process files into said circuit analysis simulator; and
performing circuit analysis on said integrated circuit model.

18. The program storage device of claim 17 wherein said parasitic interconnect couplings include device model call-ups for interconnect resistance, inductance, and capacitance.

19. The program storage device of claim 17 wherein said parasitic interconnect couplings include analytical functions for continuous prediction features.

20. The program storage device of claim 17 wherein said model process files include FET models, passive device models, and parasitic interconnect models.
